(19) United States
(12) Patent Application Publication
(10) Pub. No.: US 2015/0170418 A1
(43) Pub. Date: Jun. 18, 2015

(54) Method to Provide Entry Into a Virtual Map Space Using a Mobile Device's Camera

(71) Applicants: John Flynn, Marina del Rey, CA (US); Rafael Spring, Langquaid (DE); Dragomir Anguelov, Mountain View, CA (US); Hartmut Neven, Malibu, CA (US)

(72) Inventors: John Flynn, Marina del Rey, CA (US); Rafael Spring, Langquaid (DE); Dragomir Anguelov, Mountain View, CA (US); Hartmut Neven, Malibu, CA (US)

(73) Assignee: GOOGLE INC., Mountain View, CA (US)

(21) Appl. No.: 13/352,555

(22) Filed: Jan. 18, 2012

(51) Int. Cl. G06T 19/00; G06F 3/0481; G06F 3/0484; G06T 19/20

(52) U.S. Cl. CPC G06T 19/006; G06T 19/20; G06F 3/04815; G06F 3/04842; G06T 2200/24; G06T 2219/20

(57) ABSTRACT

The present application discloses devices and methods for providing entry into and enabling interaction with a visual representation of an environment. In some implementations, a method is disclosed that includes obtaining an estimated global pose of a device in an environment. The method further includes providing on the device a user-interface including a visual representation of the environment that corresponds to the estimated global pose. The method still further includes receiving first data indicating an object in the visual representation, receiving second data indicating an action relating to the object, and applying the action in the visual representation. In other implementations, a head-mounted device is disclosed that includes a processor and data storage including logic executable by the processor to carry out the method described above.

### BACKGROUND

Augmented reality generally refers to a real-time visual representation of a real-world environment that may be augmented with additional content. Typically, a user experiences augmented reality through the use of a computing device.

The computing device is typically configured to generate the real-time visual representation of the environment, either by allowing a user to directly view the environment or by allowing the user to indirectly view the environment by generating and displaying a real-time representation of the environment to be viewed by the user. Further, the computing device is typically configured to generate the additional content. The additional content may include, for example, one or more additional content objects that overlay the real-time visual representation of the environment.

### SUMMARY

In order to optimize an augmented reality experience of a user, it may be beneficial to transition between a real-world environment and a real-time visual representation of the real-world environment in a manner that is intuitive and user-friendly. For this reason, it may be beneficial for the visual representation of the environment to be shown from a current location and/or orientation of the user so that the user may more easily orient himself or herself within the visual representation. Further, it may be beneficial to enable a user to interact with the visual representation of the environment, for example, to modify one or more objects within the visual representation and/or to apply preferences relating to the visual representation.

The present application discloses devices and methods for providing entry into and enabling interaction with a visual representation of an environment. The disclosed devices and methods make use of an obtained estimated global pose of a device to provide on the device a visual representation that corresponds to the obtained estimated global pose. Further, the disclosed devices and methods enable a user to apply one or more actions in the visual representation.

In some implementations, a method is disclosed. The method includes obtaining an estimated global pose of a device in an environment. The method further includes providing on the device a user-interface including a visual representation of at least part of the environment. The visual representation corresponds to the estimated global pose. The method still further includes receiving first data indicating at least one object in the visual representation, receiving second data indicating an action relating to the at least one object, and applying the action in the visual representation.

In other implementations, a non-transitory computer readable medium is disclosed having stored therein instructions executable by a computing device to cause the computing device to perform the method described above.

In still other implementations, a head-mounted device is disclosed. The head-mounted device includes at least one processor and data storage including logic executable by the at least one processor to obtain an estimated global pose of the head-mounted device in an environment. The logic is further executable by the at least one processor to provide on the head-mounted device a user-interface including a visual representation of at least part of the environment, where the visual representation corresponds to the estimated global pose. The logic is still further executable by the at least one processor to receive first data indicating at least one object in the visual representation, receive second data indicating an action relating to the at least one object, and apply the action in the visual representation.

Other implementations are described below. The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE DRAWINGS

FIG. 1 is a schematic diagram of an example system, in accordance with some implementations.

FIGS. 2A-C show a simplified overview, 2A-B, and a functional block diagram, 2C, of an example head-mounted device, in accordance with some implementations.

FIG. 3 shows a block diagram of an example server, in accordance with some implementations.

FIG. 4 shows a flow chart according to some implementations of an example method for providing entry into and enabling interaction with a visual representation of an environment.

FIGS. 5A-E show example actions being applied to a visual representation of an environment, in accordance with some implementations.

FIGS. 6A-D show example preferences being applied to a visual representation of an environment, in accordance with some implementations.

### DETAILED DESCRIPTION

The following detailed description describes various features and functions of the disclosed systems and methods with reference to the accompanying figures. In the figures, similar symbols typically identify similar components, unless context dictates otherwise. The illustrative system and method implementations described herein are not meant to be limiting. It will be readily understood that certain aspects of the disclosed systems and methods can be arranged and combined in a wide variety of different configurations, all of which are contemplated herein.

### 1. Example System

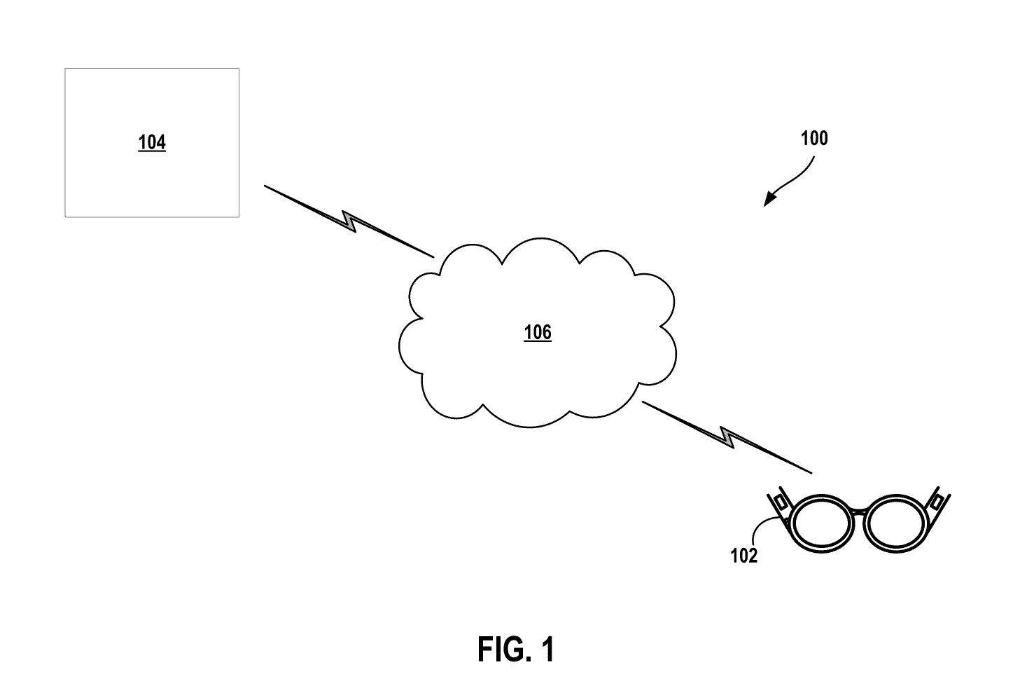

FIG. 1 is a schematic diagram of an example system 100, in accordance with some implementations. As shown, system 100 includes a head-mounted device 102 that is wirelessly coupled to a server 104 via a network 106. The network 106 may be, for example, a packet-switched network. Other networks are possible as well. While only one head-mounted device 102 and one server 104 are shown, more or fewer head-mounted devices 102 and servers 104 are possible as well.

While FIG. 1 illustrates the head-mounted device 102 as a pair of eyeglasses, other types of head-mounted devices 102 could additionally or alternatively be used. For example, the head-mounted device 102 may be one or more of a visor, headphones, a hat, a headband, an earpiece or any other type of headwear configured to wirelessly couple to the server 104. In some implementations, the head-mounted device 102 may in fact be another type of wearable or hand-held computing devices, such as a smartphone, tablet computer, or camera.

The head-mounted device 102 may be configured to obtain an estimated global pose of the head-mounted device 102. The estimated global pose may include, for example, a location of the head-mounted device 102 as well as an orientation of the head-mounted device 102. Alternatively, the estimated global pose may include a transformation, such as an affine transformation or a homography transformation, relative to a reference image having a known global pose. The estimated global pose may take other forms as well.

The head-mounted device 102 may obtain the estimated global pose by, for example, querying the server 104 for the estimated global pose. The query may include, for example, an image recorded at the head-mounted device. The image may be a still image, a frame from a video image, or a series of frames from a video. In some implementations, the query may additionally include sensor readings from one or more sensors, such as, for example, a global position system (GPS) receiver, gyroscope, compass, etc., at the head-mounted device 102. The server 104 may be configured to receive the query and, in response to receiving the query, obtain the estimated global pose of the head-mounted device 102. The server 104 may obtain the estimated global pose of the head-mounted device 102 based on the image by, for example, comparing the image with a database of reference images having known global poses, such as known locations and orientations. In implementations where the query additionally includes sensor readings, the server 104 may obtain the estimated global pose of the head-mounted device 102 based on the sensors readings as well. The server 104 may obtain the estimated global pose in other ways as well. The server 104 may be further configured to send the estimated global pose of the head-mounted device 102 to the head-mounted device 102. In implementations where the estimated global pose includes a transformation relative to a reference image, the server 104 may be further configured to send the reference image to the head-mounted device 102. The head-mounted device 102, in turn, may be further configured to receive the estimated global pose and, in some implementations, the reference image. The head-mounted device 102 may obtain the estimated global pose in other manners as well.

The head-mounted device 102 may be further configured to provide on the head-mounted device 102 a user-interface including a visual representation of at least part of an environment in which the head-mounted device 102 is located. The visual representation may correspond to the estimated global pose. For example, the visual representation may be shown from the perspective of the location and the orientation included in the estimated global pose. Other examples are possible as well.

The head-mounted device 102 may be further configured to receive data indicating objects in the visual representation, as well as actions to apply to the objects in the visual representation. The head-mounted device 102 may be still further configured to apply the actions in the visual representation.

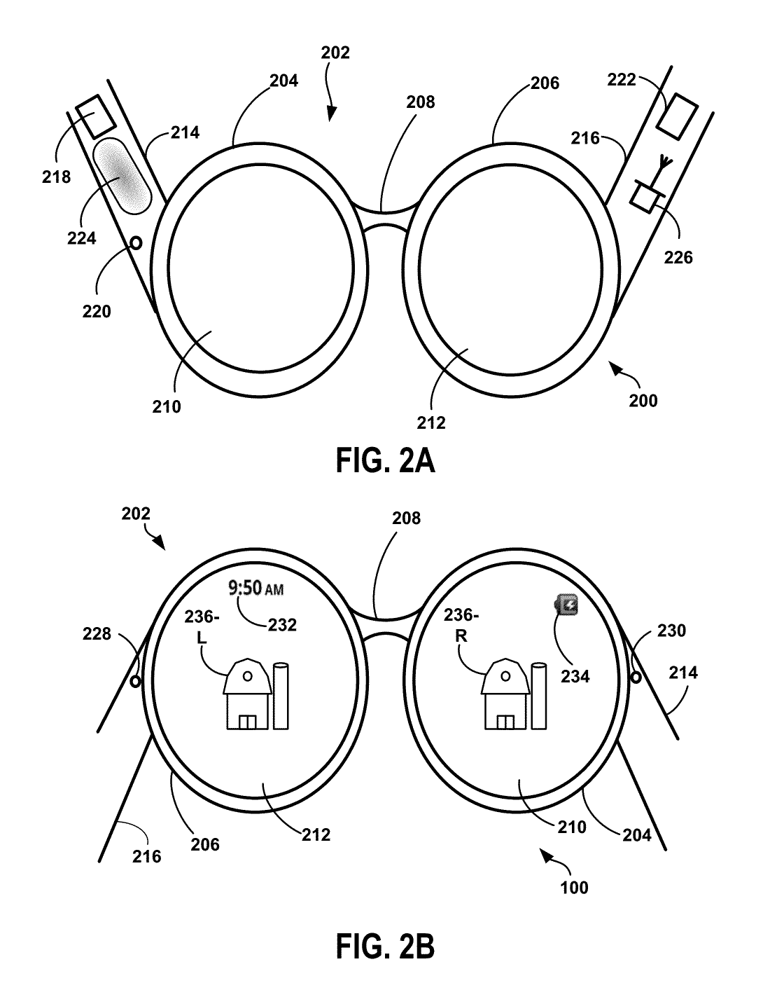

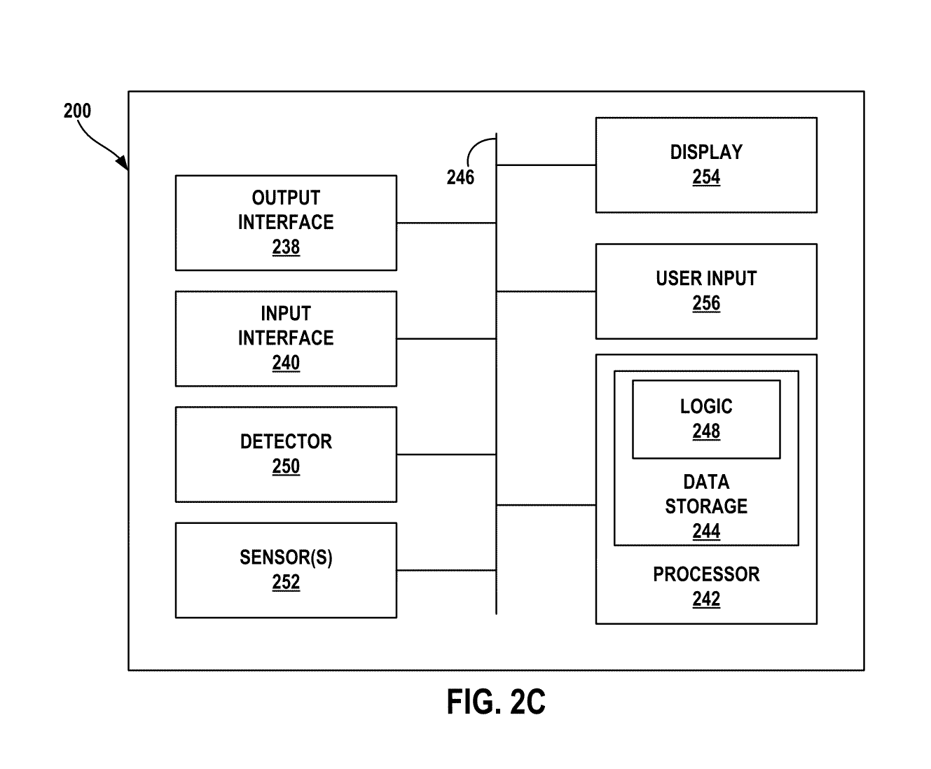

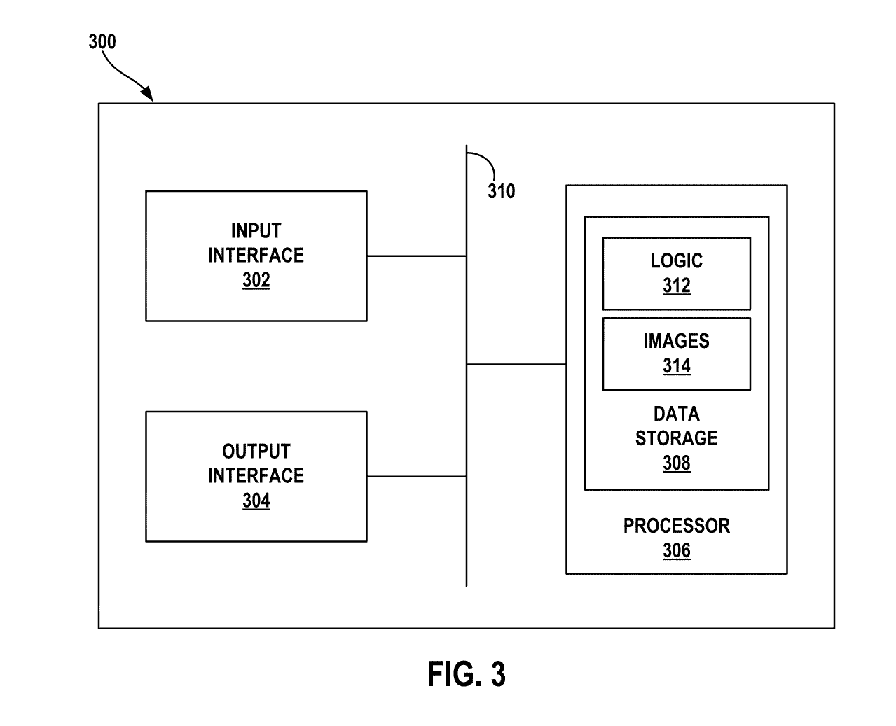

An example configuration of the head-mounted device 102 is further described below in connection with FIGS. 2A-C, while an example configuration of the server 104 is further described below in connection with FIG. 3.

### a. Example Head-Mounted Device

In accordance with some implementations, a head-mounted device may include various components, including one or more processors, one or more forms of memory, one or more sensor devices, one or more I/O devices, one or more communication devices and interfaces, and a display, all collectively arranged in a manner to make the system wearable by a user. The head-mounted device may also include machine-language logic, such as software, firmware, and/or hardware instructions, stored in one or another form of memory and executable by one or another processor of the system in order to implement one or more programs, tasks, applications, or the like. The head-mounted device may be configured in various form factors, including, without limitation, being integrated with a head-mounted display (HMD) as a unified package, or distributed, with one or more elements integrated in the HMD and one or more others separately wearable on other parts of a user's body, such as, for example, as a garment, in a garment pocket, as jewelry, etc.

FIGS. 2A and 2B show a simplified overview of an example head-mounted device, in accordance with some implementations. In this example, the head-mounted device 200 is depicted as a wearable HMD taking the form of eyeglasses 202. However, it will be appreciated that other types of wearable computing devices, head-mounted or otherwise, could additionally or alternatively be used.

As illustrated in FIG. 2A, the eyeglasses 202 include frame elements including lens-frames 204 and 206 and a center frame support 208, lens elements 210 and 212, and extending side-arms 214 and 216. The center frame support 208 and the extending side-arms 214 and 216 are configured to secure the eyeglasses 202 to a user's face via a user's nose and ears, respectively. Each of the frame elements 204, 206, and 208 and the extending side-arms 214 and 216 may be formed of a solid structure of plastic or metal, or may be formed of a hollow structure of similar material so as to allow wiring and component interconnects to be internally routed through the eyeglasses 202. Each of the lens elements 210 and 212 may include a material on which an image or graphic can be displayed. In addition, at least a portion of each lens elements 210 and 212 may be sufficiently transparent to allow a user to see through the lens element. These two features of the lens elements could be combined; for example, to provide an augmented reality or heads-up display where the projected image or graphic can be superimposed over or provided in conjunction with a real-world view as perceived by the user through the lens elements.

The extending side-arms 214 and 216 are each projections that extend away from the frame elements 204 and 206, respectively, and are positioned behind a user's ears to secure the eyeglasses 202 to the user. The extending side-arms 214 and 216 may further secure the eyeglasses 202 to the user by extending around a rear portion of the user's head. Additionally or alternatively, the wearable computing system 200 may be connected to or be integral to a head-mounted helmet structure. Other possibilities exist as well.

The wearable computing system 200 may also include an on-board computing system 218, a video camera 220, one or more sensors 222, a finger-operable touch pad 224, and a communication interface 226. The on-board computing system 218 is shown to be positioned on the extending side-arm 214 of the eyeglasses 202; however, the on-board computing system 218 may be provided on other parts of the eyeglasses 202. The on-board computing system 218 may include, for example, one or more processors and one or more forms of memory. The on-board computing system 218 may be configured to receive and analyze data from the video camera 220, the sensors 222, the finger-operable touch pad 224, and the wireless communication interface 226, and possibly from other sensory devices and/or user interfaces, and generate images for output to the lens elements 210 and 212.

The video camera 220 is shown to be positioned on the extending side-arm 214 of the eyeglasses 202; however, the video camera 220 may be provided on other parts of the eyeglasses 202. The video camera 220 may be configured to capture images at various resolutions or at different frame rates. Video cameras with a small form factor, such as those used in cell phones or webcams, for example, may be incorporated into an example of the wearable system 200. Although FIG. 2A illustrates one video camera 220, more video cameras may be used, and each may be configured to capture the same view, or to capture different views. For example, the video camera 220 may be forward facing to capture at least a portion of a real-world view perceived by the user. This forward facing image captured by the video camera 220 may then be used to generate an augmented reality where computer generated images appear to interact with the real-world view perceived by the user.

The sensors 222 are shown mounted on the extending side-arm 216 of the eyeglasses 202; however, the sensors 222 may be provided on other parts of the eyeglasses 202. Although depicted as a single component, the sensors 222 in FIG. 2A could include more than one type of sensor device or element. By way of example and without limitation, the sensors 222 could include one or more of a motion sensor, such as a gyroscope and/or an accelerometer, a location determination device, such as a GPS device, a magnetometer, and an orientation sensor. Other sensing devices or elements may be included within the sensors 222 and other sensing functions may be performed by the sensors 222.

The finger-operable touch pad 224, shown mounted on the extending side-arm 214 of the eyeglasses 202, may be used by a user to input commands. The finger-operable touch pad 224 may sense at least one of a position and a movement of a finger via capacitive sensing, resistance sensing, or a surface acoustic wave process, among other possibilities. The finger-operable touch pad 224 may be capable of sensing finger movement in a direction parallel to the pad surface, in a direction normal to the pad surface, or both, and may also be capable of sensing a level of pressure applied. The finger-operable touch pad 224 may be formed of one or more translucent or transparent insulating layers and one or more translucent or transparent conducting layers. Edges of the finger-operable touch pad 224 may be formed to have a raised, indented, or roughened surface, so as to provide tactile feedback to a user when the user's finger reaches the edge of the finger-operable touch pad 224. Although not shown in FIG. 2A, the eyeglasses 202 could include one more additional finger-operable touch pads, for example attached to the extending side-arm 216, which could be operated independently of the finger-operable touch pad 224 to provide a duplicate and/or different function.

The communication interface 226 could include an antenna and transceiver device for support of wireline and/or wireless communications between the wearable computing system 100 and a remote device or communication network. For instance, the communication interface 226 could support wireless communications with any or all of 3G and/or 4G cellular radio technologies, such as CDMA, EVDO, GSM, UMTS, LTE, WiMAX, etc., as well as wireless local or personal area network technologies such as a Bluetooth, Zigbee, and WiFi, such as 802.11a, 802.11b, 802.11g, etc. Other types of wireless access technologies could be supported as well. The communication interface 226 could enable communications between the head-mounted device 200 and one or more end devices, such as another wireless communication device, such as a cellular phone or another wearable computing device, a computer in a communication network, or a server or server system in a communication network. The communication interface 226 could also support wired access communications with Ethernet or USB connections, for example.

FIG. 2B illustrates another view of the head-mounted device 200 of FIG. 2A. As shown in FIG. 2B, the lens elements 210 and 212 may act as display elements. In this regard, the eyeglasses 202 may include a first projector 228 coupled to an inside surface of the extending side-arm 216 and configured to project a display image 232 onto an inside surface of the lens element 212. Additionally or alternatively, a second projector 230 may be coupled to an inside surface of the extending side-arm 214 and configured to project a display image 234 onto an inside surface of the lens element 210.

The lens elements 210 and 212 may act as a combiner in a light projection system and may include a coating that reflects the light projected onto them from the projectors 228 and 230. Alternatively, the projectors 228 and 230 could be scanning laser devices that interact directly with the user's retinas.

A forward viewing field may be seen concurrently through lens elements 210 and 212 with projected or displayed images, such as display images 232 and 234. This is represented in FIG. 2B by the field of view (FOV) object 236-L in the left lens element 212 and the same FOV object 236-R in the right lens element 210. The combination of displayed images and real objects observed in the FOV may be one aspect of augmented reality, referenced above.

In alternative implementations, other types of display elements may also be used. For example, lens elements 210, 212 may include: a transparent or semi-transparent matrix display, such as an electroluminescent display or a liquid crystal display; one or more waveguides for delivering an image to the user's eyes; and/or other optical elements capable of delivering an in focus near-to-eye image to the user. A corresponding display driver may be disposed within the frame elements 204 and 206 for driving such a matrix display. Alternatively or additionally, a scanning laser device, such as low-power laser or LED source and accompanying scanning system, can draw a raster display directly onto the retina of one or more of the user's eyes. The user can then perceive the raster display based on the light reaching the retina.

Although not shown in FIGS. 2A and 2B, the head-mounted device 200 can also include one or more components for audio output. For example, head-mounted device 200 can be equipped with speakers, earphones, and/or earphone jacks. Other possibilities exist as well.

While the head-mounted device 200 of the example implementations illustrated in FIGS. 2A and 2B is configured as a unified package, integrated in the HMD component, other configurations are possible as well. For example, although not explicitly shown in FIGS. 2A and 2B, the head-mounted device 200 could be implemented in a distributed architecture in which all or part of the on-board computing system 218 is configured remotely from the eyeglasses 202. For example, some or all of the on-board computing system 218 could be made wearable in or on clothing as an accessory, such as in a garment pocket or on a belt clip. Similarly, other components depicted in FIGS. 2A and/or 2B as integrated in the eyeglasses 202 could also be configured remotely from the eyeglasses 202. In such a distributed architecture, certain components might still be integrated in eyeglasses 202. For instance, one or more sensors, such as an accelerometer and/or an orientation sensor, could be integrated in eyeglasses 202.

In an example distributed configuration, the eyeglasses 202, including other integrated components, could communicate with remote components via the communication interface 226, or via a dedicated connection, distinct from the communication interface 226. By way of example, a wired, such as, e.g., USB or Ethernet, or wireless, such as, e.g., WiFi or Bluetooth, connection could support communications between a remote computing system and the eyeglasses 202. Additionally, such a communication link could be implemented between the eyeglasses 202 and other remote devices, such as a laptop computer or a mobile telephone, for instance.

FIG. 2C shows a functional block diagram of an example head-mounted device, in accordance with some implementations. As shown, the head-mounted device 200 includes an output interface 238, an input interface 240, a processor 242, and data storage 244, all of which may be communicatively linked together by a system bus, network, and/or other connection mechanism 246.

The output interface 238 may be any interface configured to send to a server a query for an estimated global pose. For example, the output interface 238 could be a wireless interface, such as any of the wireless interfaces described above. In some implementations, the output interface 238 may also be configured to wirelessly communicate with one or more entities besides the server.

The input interface 240 may be any interface configured to receive from the server the estimated global pose of the head-mounted device 200. As noted above, the estimated global pose may include, for example, an estimated location of the head-mounted device 200 and an estimated orientation of the head-mounted device 200. Alternatively, the estimated global pose may include a transformation, such as, for example, an affine transformation or a homography transformation, relative to a reference image having a known global pose. In these implementations, the input interface 240 may be further configured to receive the reference image from the server. The estimated global pose may take other forms as well. The input interface 240 may be, for example, a wireless interface, such as any of the wireless interfaces described above. The input interface 240 may take other forms as well. In some implementations, the input interface 240 may also be configured to wirelessly communicate with one or more entities besides the server. Further, in some implementations, the input interface 240 may be integrated in whole or in part with the output interface 238.

The processor 242 may include one or more general-purpose processors and/or one or more special-purpose processors. To the extent the processor 242 includes more than one processor, such processors may work separately or in combination. The processor 242 may be integrated in whole or in part with the output interface 238, the input interface 240, and/or with other components.

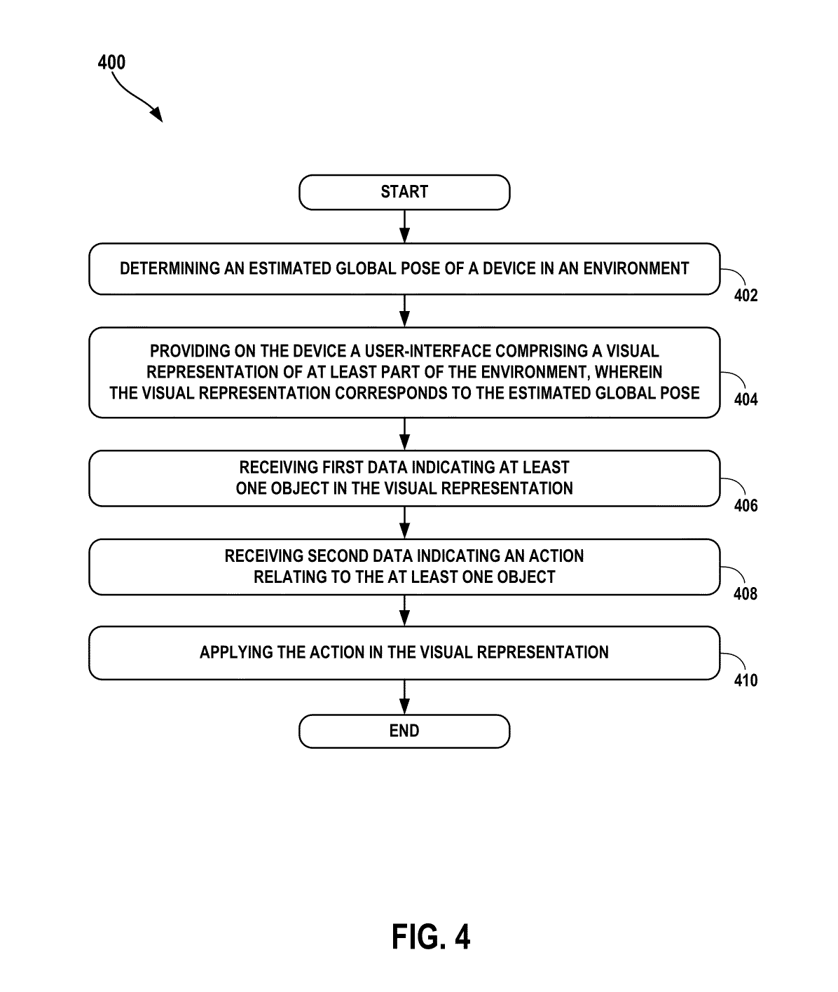

Data storage 244, in turn, may include one or more volatile and/or one or more non-volatile storage components, such as optical, magnetic, and/or organic storage, and data storage 244 may be integrated in whole or in part with the processor 242. As shown, data storage 244 contains logic 248 executable by the processor 242 to carry out various head-mounted device functions, such as, for example, the head-mounted device functions described below in connection with FIG. 4, including providing on the head-mounted device a user-interface including a visual representation of an environment in which the device is located, receiving data indicating objects in the visual representation as well as actions to apply to the objects in the visual representation, and applying the actions in the visual representation.

In some implementations, the head-mounted device 200 may additionally include a detector 250, as shown. The detector may be configured to record an image of at least a part of the environment in which the head-mounted device 200 is located. To this end, the detector may be, for example, a camera or other imaging device. The detector may be a two-dimensional detector, or may have a three-dimensional spatial range. In some implementations, the detector may be enhanced through sensor fusion technology. The detector may take other forms as well. In this example, the output interface 238 may be further configured to send the image to the server as part of the query.

Further, in some implementations, the head-mounted device 200 may additionally include one or more sensors 252 configured to determine at least one sensor reading. For example, the sensors 252 may include a location sensor, such as a global position system (GPS) receiver, and/or an orientation sensor, such as a gyroscope and/or a compass. In this example, the output interface 238 may be further configured to send the at least one sensor reading to the server as part of the query. Alternatively or additionally, in this example the head-mounted device 200 may be further configured to obtain the estimated global pose using the at least one sensor reading. For instance, the head-mounted device 200 may cause a location sensor to obtain an estimated location of the head-mounted device 200 and may cause an orientation sensor to obtain an estimated orientation of the head-mounted device 200. The head-mounted device 200 may then obtain the estimated global pose based on the estimated location and orientation. In another example, the sensors 252 may include at least one motion sensor configured to detect movement of the head-mounted device 200. The motion sensor may include, for example, an accelerometer and/or a gyroscope. The motion sensor may include other sensors as well. The movement of the head-mounted device 200 detected by the motion sensor may correspond to, for example, the data indicating objects in the visual representation and/or actions to apply to the objects in the visual representation.

Still further, in some implementations, the head-mounted device 200 may additionally include a display 254 configured to display some or all of the user-interface including the visual representation. The display may be, for example, an HMD, and may include any of the displays described above.

Still further, in some implementations, the head-mounted device 200 may additionally include one or more user input controls 256 configured to receive input from and provide output to a user of the head-mounted device 200. User input controls 256 may include one or more of touchpads, buttons, a touchscreen, a microphone, and/or any other elements for receiving inputs, as well as a speaker and/or any other elements for communicating outputs. Further, the head-mounted device 200 may include analog/digital conversion circuitry to facilitate conversion between analog user input/output and digital signals on which the head-mounted device 200 can operate.

The head-mounted device 200 may include one or more additional components instead of or in addition to those shown. For instance, the head-mounted device 200 could include one or more of video cameras, still cameras, infrared sensors, optical sensors, biosensors, Radio Frequency identification (RFID) systems, wireless sensors, pressure sensors, temperature sensors, and/or magnetometers, among others. Depending on the additional components of the head-mounted device 200, data storage 244 may further include logic executable by the processor 242 to control and/or communicate with the additional components, and/or send to the server data corresponding to the additional components.

### b. Example Server

FIG. 3 shows a block diagram of an example server 300, in accordance with some implementations. As shown, the server 300 includes an input interface 302, an output interface 304, a processor 306, and data storage 308, all of which may be communicatively linked together by a system bus, network, and/or other connection mechanism 310.

The input interface 302 may be any interface configured to receive a query sent by a head-mounted device, such as the head-mounted device 200 described above. The query may include, for example, an image recorded by a detector on the head-mounted device and/or one or more sensor readings obtained from one or more sensors on the head-mounted device. The input interface 302 may be a wireless interface, such as any of the wireless interfaces described above. Alternatively or additionally, the input interface 302 may be a web-based interface accessible by a user of the head-mounted device. The input interface 302 may take other forms as well. In some implementations, the input interface 302 may also be configured to wirelessly communicate with one or more entities besides the head-mounted device.

The output interface 304 may be any interface configured to send an estimated global pose of the head-mounted device to the head-mounted device. As noted above, the estimated global pose may include, for example, a location of the head-mounted device as well as an orientation of the head-mounted device. Alternatively, the estimated global pose may include a transformation, such as an affine transformation or a homography transformation, relative to a reference image having a known global pose. In these implementations, the output interface 304 may be further configured to send the reference image to the head-mounted device. The estimated global pose may take other forms as well. The output interface 304 may be a wireless interface, such as any of the wireless interfaces described above. Alternatively or additionally, the output interface 304 may be a web-based interface accessible by a user of the head-mounted device. The output interface 304 may take other forms as well. In some implementations, the output interface 304 may also be configured to wirelessly communicate with one or more entities besides the head-mounted device. In some implementations, the output interface 304 may be integrated in whole or in part with the input interface 302.

The processor 306 may include one or more general-purpose processors and/or one or more special-purpose processors. To the extent the processor 306 includes more than one processor, such processors could work separately or in combination. Further, the processor 306 may be integrated in whole or in part with the input interface 302, the output interface 304, and/or with other components.

Data storage 308, in turn, may include one or more volatile and/or one or more non-volatile storage components, such as optical, magnetic, and/or organic storage, and data storage 308 may be integrated in whole or in part with the processor 306. Data storage 308 may include logic executable by the processor 306 to obtain the estimated global pose of the head-mounted device.

In some implementations, obtaining the estimated global pose may involve, for example, comparing an image recorded at the head-mounted device and/or information associated with the image such as, for example, one or more visual features, e.g., colors, shapes, textures, brightness levels, shapes, of the image, with a database of images 314. The database of images 314 may be stored in the data storage 308, as shown, or may be otherwise accessible by the server 300. Each image in the database of images 314 may be associated with information regarding a location and/or orientation from which the image was recorded. Thus, in order to obtain the estimated global pose of the head-mounted device, the server 300 may compare the image recorded at the head-mounted device with some or all of the images in the database of images 314 in order to obtain an estimated location and/or estimated orientation of the head-mounted device. Based on the estimated location and/or the estimated orientation of the head-mounted device, the server 300 may obtain an estimated global pose. Alternatively, in order to obtain the estimated global pose of the head-mounted device, the server may select from the database of images 314 a reference image, and may compare the image recorded at the head-mounted device with the reference image in order to determine a transformation, such as, for example, an affine transformation or a homography transformation, for the image recorded at the head-mounted device relative to the reference image. Based on the transformation, the server 300 may obtain the estimated global pose.

As noted above, in some implementations, the query received by the server 300 may additionally include an image recorded by a detector on the head-mounted device and/or one or more sensor readings obtained from one or more sensors on the head-mounted device. In these implementations, the server 300 may additionally use the image and/or sensor readings in obtaining the estimated global pose. The server 300 may obtain the estimated global pose in other manners as well.

The server 300 may further include one or more elements in addition to or instead of those shown.

### 2. Example Method

FIG. 4 shows a flow chart according to some implementations of an example method for providing entry into and enabling interaction with a visual representation of an environment.

Method 400 shown in FIG. 4 presents some implementations of a method that, for example, could be used with the systems, head-mounted devices, and servers described herein. Method 400 may include one or more operations, functions, or actions as illustrated by one or more of blocks 402-410. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

In addition, for the method 400 and other processes and methods disclosed herein, the flowchart shows functionality and operation of one possible implementation of present implementations. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, and compact-disc read only memory (CD-ROM), for example. The computer readable medium may also be any other volatile or non-volatile storage systems. The computer readable medium may be considered a computer readable storage medium, a tangible storage device, or other article of manufacture, for example.

In addition, for the method 400 and other processes and methods disclosed herein, each block may represent circuitry that is wired to perform the specific logical functions in the process.

As shown, the method 400 begins at block 402 where a device in an environment, such as the head-mounted device 200 described above, obtains an estimated global pose of the device. The estimated global pose of the device may include an estimate of a location, such as a three-dimensional location, e.g., latitude, longitude, and altitude, of the device and an orientation, such as a three-dimensional orientation, e.g., pitch, yaw, and roll, of the device. Alternatively, the estimated global pose may include a transformation, such as, for example, an affine transformation or a homography transformation, relative to a reference image having a known global pose. The estimated global pose may take other forms as well. The device may obtain the estimated global pose in several ways.

In some implementations, the device may obtain the estimated global pose of the device by querying a server, such as the server 300 described above, for the estimated global pose. The device may include several types of information in the query. For example, the device may include in the query an image of at least part of the environment, as, for example, recorded at the device. In some implementations, the query may include the image in, for example, a compressed format. In other implementations, prior to sending the query, the device may analyze the image to identify information associated with the image such as, for example, one or more visual features, e.g., colors, shapes, textures, brightness levels, shapes, of the image. In these implementations, the query may alternatively or additionally include an indication of the information associated with the image. As another example, the device may include in the query one or more sensor readings taken at sensors on the device, such as a location sensor and/or an orientation sensor. Other examples are possible as well. The server may obtain the estimated global pose based on the query, e.g., based on the image and/or the sensor readings, and send the estimated global pose to the device, and the device may receive the estimated global pose.

In other implementations, the device may obtain the estimated global pose using one or more sensors on the device. For example, the device may cause one or more location sensors, such as, for example, a global position system (GPS) receiver, to obtain an estimated location of the device 102 and may cause one or more orientation sensors such as, for example, a gyroscope and/or a compass, to obtain an estimated orientation of the device. The device may then obtain the estimated global pose based on the estimated location and orientation.

The device may obtain the estimated global pose in other manners as well.

The method 400 continues at block 404 where the device provides on the device a user-interface including a visual representation of at least part of the environment. The device may provide the user-interface by, for example, displaying at least part of the user-interface on a display of the device.

The visual representation corresponds to the estimated global pose. For example, the visual representation may depict the environment shown from the perspective of the three-dimensional location and three-dimensional orientation of the device. As another example, the visual representation may depict a panoramic view of the environment centered at the three-dimensional location of the device and shown from the perspective of the three-dimensional orientation of the device. As yet another example, the visual representation may be an overhead or satellite view centered at two dimensions, e.g., latitude and longitude, of the three-dimensional location and two dimensions, e.g., yaw and roll, or three dimensions, e.g., pitch, yaw, and roll, of the three-dimensional orientation. The visual representation may take other forms as well.

In order to provide the user-interface, the device may generate the visual representation by, for example, sending a query, e.g., to a database server, for querying a database of images or geometric representations with the estimated global pose. The database server may use the estimated global pose as a basis to select one or more images or geometric representations from the database for use in generating the visual representation, and may provide the one or more images to the device. The device may then use the images or geometric representations as a basis to generate the visual representation. In some implementations, the device may include in the query one or more preferences relating to the visual representation, such as a view type of the visual representation, and the database may use the preferences along with the estimated global pose as a basis to select the one or more images for use as the visual representation. Example view types includes an overhead view, a panoramic view, a satellite view, a photographed view, a rendered-image view, a map view, a street view, a landmark view, an historical view, an annotation view, in which information about the environment is overlaid on the environment, a graffiti view, in which text and/or graphics provided by users are overlaid on the environment, or any combination thereof. Other view types are possible as well. The preferences included in the query may be specified by a user of the device, may be default preferences, or may be selected by the device randomly or based on one or more criteria.

In some implementations, the database of images or geometric representations may be included in the server. In these implementations, the query to the server and the query for the visual representation may be combined, so as to include, for example, an image and/or sensor reading as well as one or more preferences relating to the visual representation. The server may use the image and/or sensor reading as a basis to obtain the estimated global pose, and may use the preferences along with the estimated global pose as a basis to select one or more images or geometric representations. The server may then provide the device with both the estimated global pose and the images or geometric representations for use in generating the visual representation.

The device may provide the visual representation on the device in other ways as well.

The method 400 continues at block 406 where the device receives first data indicating at least one object in the visual representation. The object may be, for example, a discrete object in the visual representation, such as a building. Alternatively, the object may be, for example, a portion of an object in the visual representation, such as the top of a building. Still alternatively, the object may be two or more discrete objects, such as a building and a tree. Other objects are possible as well.

The device may receive the first data by, for example, detecting one or more predefined movements using, for example, one or more motion sensors. The predefined movements may take several forms.

In some implementations, the predefined movements may be movements of the device. In implementations where the device is a head-mounted device, the predefined movements may correspond to predefined movements of a user's head. In other implementations, the predefined movements may be movements of a peripheral device communicatively coupled to the device. The peripheral device may be wearable by a user, such that the movements of the peripheral device may correspond to movements of the user, such as, for example, movements of the user's hand. In yet other implementations, the predefined movements may be input movements, such as, for example, movements across a finger-operable touch pad or other input device. The predefined movements may take other forms as well.

In some implementations, the predefined movements may be user friendly and/or intuitive. For example, the predefined movement corresponding to the first data may be a “grab” movement in which a user selects the object by pointing or grabbing, e.g., with a hand, cursor, or other pointing device, over the object in the visual representation. Other examples are possible as well.

At block 408, the device receives second data indicating an action relating to the at least one object. The action may be, for example, removing a portion or all of an object, e.g., removing a building, or removing a wall or a portion of a wall of a building, or otherwise modifying the object, overlaying the object with additional information associated with the object, replacing the object with one or more new objects, e.g., replacing a building with another building, or with an historic image of the same building, overlaying the visual representation with one or more new objects, and/or changing the size, shape, color, depth and/or age of the object. Other actions are possible as well.

The device may receive the second data by detecting one or more predefined movements using, for example, one or more motion sensors. The predefined movements may take any of the forms described above.

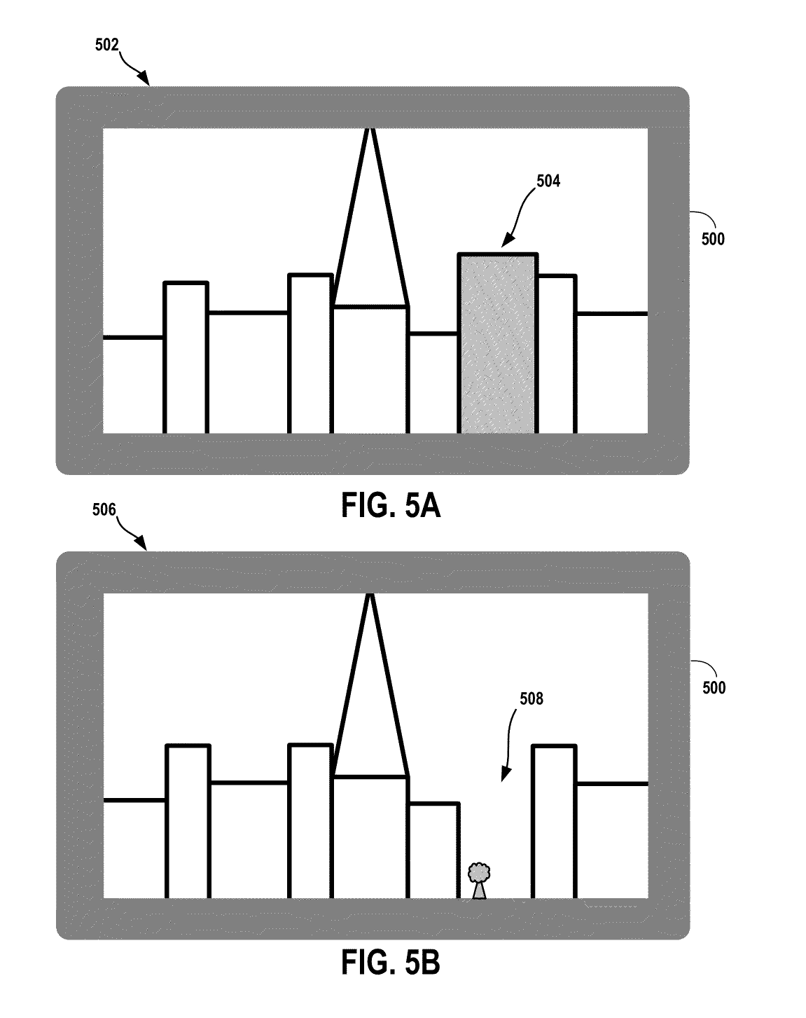

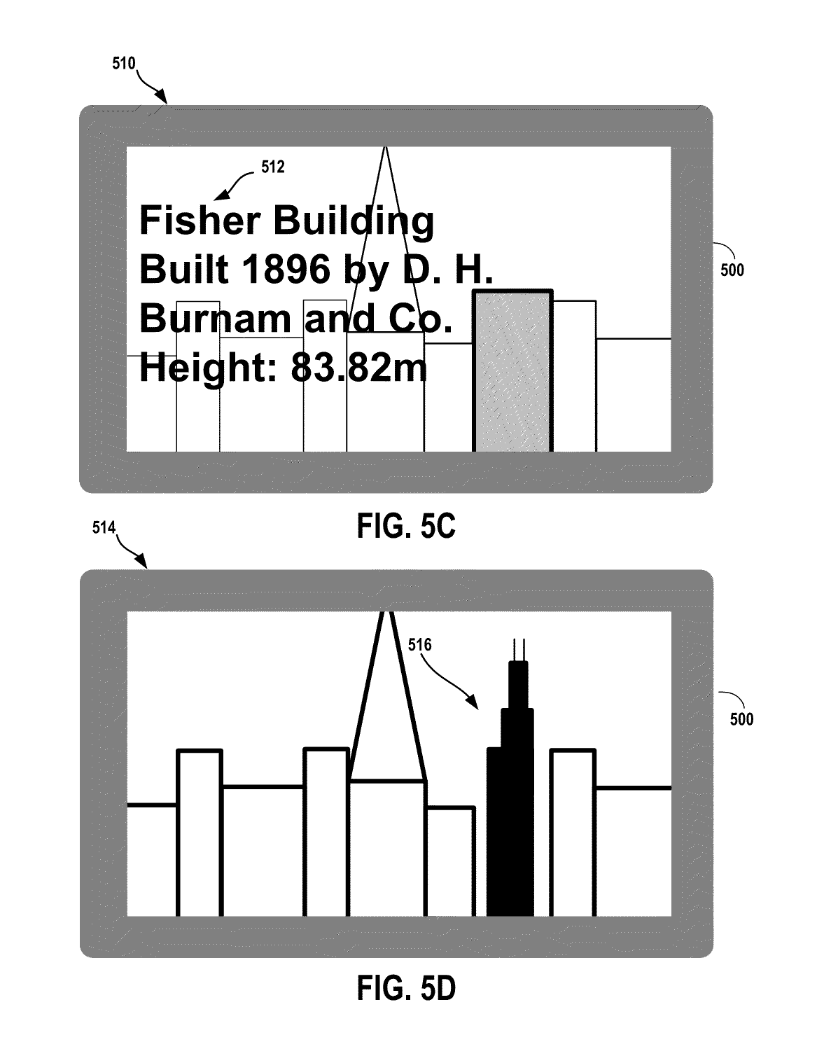

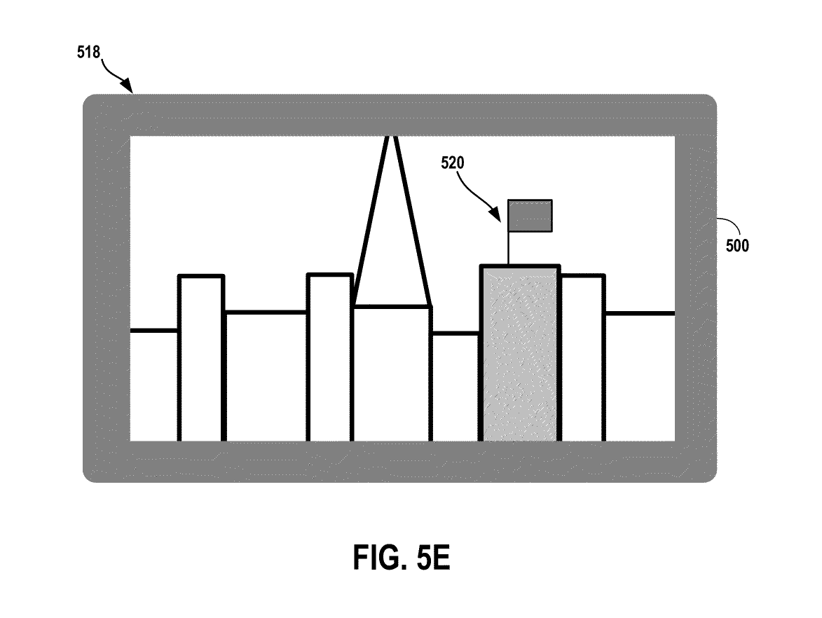

At block 410, the device applies the action in the visual representation. For example, if the first data indicates a building and the second data indicates removing the building, the device may apply the action by removing the building. Other examples are possible as well. Some example applied actions are described below in connection with FIGS. 5A-E.

Once the visual representation is provided by the device, the device may continue to receive data indicating objects and/or actions and apply the actions in the visual representation.

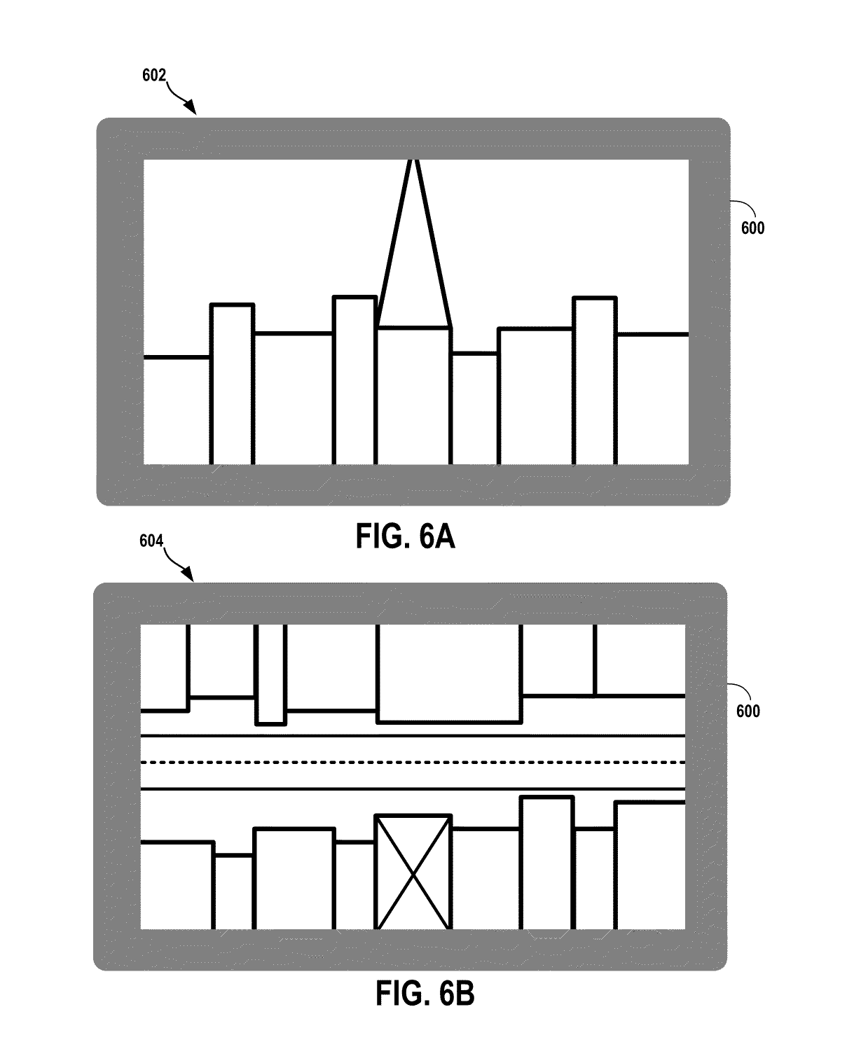

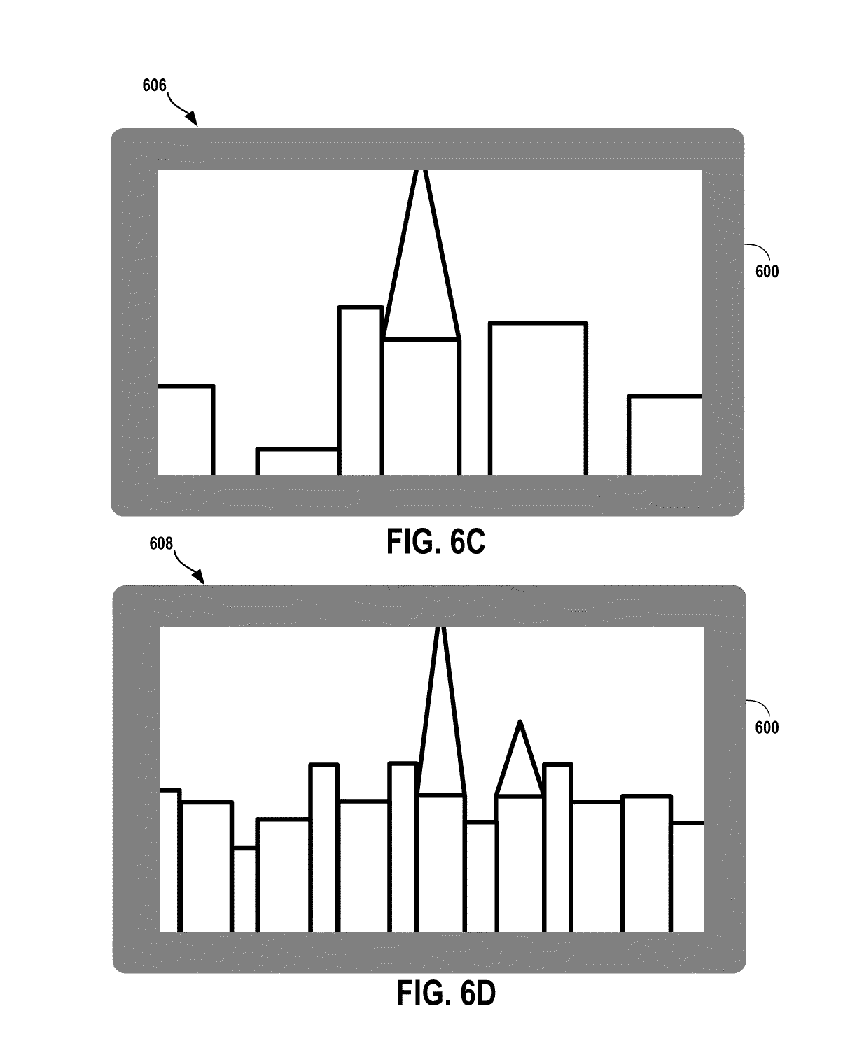

In some implementations, the method 400 may further include the device receiving third data indicating a preference relating to the visual representation. The device may receive the third data by detecting one or more predefined movements using, for example, one or more motion sensors. The predefined movements may take any of the forms described above. After receiving the third data, the device may apply the preference to the visual representation. Some example applied preferences are described below in connection with FIGS. 6A-D.

### 3. Example Implementations

FIGS. 5A-E show example actions being applied to a visual representation of an environment, in accordance with some implementations.

FIG. 5A shows a visual representation 500 that includes a number of objects. The device 500 may receive data indicating any of the objects, such as the object 504. After receiving the data indicating the object 504, the device 500 may receive data indicating an action to be applied to the object 504.

In one example, the action may be removing the object 504. FIG. 5B shows a visual representation 506 in which the object 504 has been removed. In the visual representation 506, the object 504 has been removed, such that the landscape 508 behind the object 504 is shown. In some implementations, when the object 504 is removed, the landscape where the object 504 was located will be displayed as it was before the object 504 was built or otherwise added to the environment. While in FIG. 5B the entirety of object 504 has been removed, in other implementations, only a portion or a layer of object 504 could be removed. For example, only the top stories of the object 504 could be removed so that the visual representation 506 showed a portion of the landscape 508 behind the object 504. As another example, some or all of the front wall of the object 504 could be removed so that the visual representation 506 showed the interior of the object 504. Other examples are possible as well.

In another example, the action may be overlaying the object 504 with additional information 512. FIG. 5C shows a visual representation 510 in which the visual representation 510 has been overlaid with additional information 512 associated with the object 504. The additional information may include text and/or images associated with the object 504. Other types of additional information are possible as well. The additional information 512 may, for example, be previously stored on the device. Alternatively, the additional information may be retrieved by the device 500 using, for example, an image and/or text based query. Other examples are possible as well.

In yet another example, the action may be replacing the object 504 with a new object 516. FIG. 5D shows a visual representation 514 in which the object 504 has been replaced with the new object 516. The new object 516 may be specified by the user, may be a default new object, or may be selected by the device 500 randomly or based on one or more criteria. The new object 516 may be selected in other ways as well.

In still another example, the action may be overlaying the visual representation with an additional object 520. FIG. 5E shows a visual representation 518 in which the visual representation 518 is overlaid with the additional object 520. The additional object 520 may be specified by the user, may be a default additional object, or may be selected by the device 500 randomly or based on one or more criteria. The additional object 520 may be selected in other ways as well. Further, the location of the additional object 520 may be specified by the user, may be a default location, or may be selected by the device 500 randomly or based on one or more criteria. The location may be selected in other ways as well. In some implementations, the additional object 520 may be a static object. In other implementations, the additional object 520 may be an animated object. For example, the additional object 520, shown as a flag, may wave. Other examples are possible as well.

Additional actions are possible as well. For instance, objects in the visual representation may be changed in size, shape, color, depth, age, or other ways. Other examples are possible as well.

In addition to applying actions to the visual representation, a user of the device may modify preferences relating to the visual representation. Upon receiving data indicating the preference, the device may apply the preference to the visual representation. The preferences may include one or more of color, e.g., color, black and white, grayscale, sepia, etc., shape, e.g., widescreen, full screen, etc., size and magnification, e.g., zoomed in, zoomed out, etc., medium, e.g., computer-aided design, hand-drawn, painted, etc., or view type preferences. Other preferences are possible as well.

As noted above, example view types include an overhead view, a panoramic view, a satellite view, a photographed view, a rendered-image view, a map view, a street view, a landmark view, an historical view, an annotation view, a graffiti view, or any combination thereof. Other view types are possible as well. Each of the view types may be applied in combination with any of the above preferences, and any of the above actions may be applied along with any of the view types.

FIGS. 6A-D show example preferences being applied to a visual representation of an environment, in accordance with some implementations.

FIG. 6A shows a visual representation 602 on a device 600 in which a street view type has been applied. The street view may, for example, be similar to a view seen by a user of the device 600 without the device 600. To this end, the street view may be shown from the estimated global pose of the device, e.g., the three-dimensional location and three-dimensional orientation of the device, and, in turn the user.

FIG. 6B shows a visual representation 604 on the device 600 in which an overhead view type has been applied. The overhead view may be shown centered at, for example, two dimensions, e.g., latitude and longitude, of the three-dimensional location and two dimensions, e.g., yaw and roll, or three dimensions, e.g., pitch, yaw, and roll, of the three-dimensional orientation. An altitude of the overhead view may be specified by a user, may be a default altitude, or may be selected by the device 600 randomly or based on one or more criteria.

FIG. 6C shows a visual representation 606 on the device 600 in which an historical view type has been applied. The historical view may show the environment of the visual representation as it appeared during an historical time. A time period of the historical view may be specified by a user, may be a default time period, or may be selected by the device 600 randomly or based on one or more criteria. The historical view may be shown from the three-dimensional location and three-dimensional orientation of the user. In some implementations, the historical view may additionally include a number of animated objects that are added to the visual representation. For example, in an historical view of Rome, a number of animated Roman guards that patrol the historical Rome may be shown. Other examples are possible as well.

FIG. 6D shows a visual representation 608 on the device in which a panoramic view type has been applied. The panoramic view may, for example, be similar to the street view with the exception that a larger, e.g., wider, area may be visible in the panoramic view type. The panoramic view may be shown from the three-dimensional location and three-dimensional orientation of the user.

Other view types besides those shown are possible as well. In any view type, the visual representation may include one or both of photographic and rendered images.

### 4. CONCLUSION

While various aspects and implementations have been disclosed herein, other aspects and implementations will be apparent to those skilled in the art. The various aspects and implementations disclosed herein are for purposes of illustration and are not intended to be limiting, with the true scope and spirit being indicated by the following claims.

1. A computer-implemented method comprising:
obtaining an estimated location of a computing device and an estimated orientation of the computing device;
sending a query indicating the estimated location and the estimated orientation of the computing device to a remote server;
receiving, from the remote server, first data representing at least a portion of an environment in which the computing device is located, wherein the first data includes an image of the portion of the environment, and wherein the image is stored at the remote server before receiving the first data;
obtaining a visual representation of the portion of the environment in which the computing device is located using the image of the portion of the environment received from the remote server;
providing, for display by the computing device, a user-interface including the visual representation of the portion of the environment in which the computing device is located;
receiving second data indicating (i) a selection of a first object within the visual representation that is obtained using the image received from the remote server, and (ii) an action relating to the object, wherein the action includes modifying the first object within the visual representation to generate a second object;
obtaining an updated visual representation of the portion of the environment in which the computing device is located based on the second data indicating (i) the selection of the first object within the visual representation, and (ii) the action relating to the first object, wherein the updated visual representation includes the second object and does not include the first object; and
providing, for display by the computing device, an updated user interface including the updated visual representation of the portion of the environment in which the computing device is located.

2.-20. (canceled)

21. The method of claim 1, wherein the query includes a first image of the portion of the environment.

22. The method of claim 1, wherein the first data includes a geometric representation of the portion of the environment.

23. The method of claim 1, comprising:
obtaining a query image including a first representation of the portion of the environment in which the computing device is located,
wherein sending the query includes sending the query image including the first representation,
wherein receiving the first data includes receiving the image representing a second representation of the portion of the environment that is different from the first representation included in the query image.

24. The method of claim 23, wherein the second representation of the portion of the environment represents an earlier representation of the portion of the environment in time than the first representation.

25. The method of claim 23, wherein a visual perspective of the second representation is different from a visual perspective of the first representation.

26. The method of claim 1,
wherein the first data include information identifying one or more objects within the portion of the environment, and
wherein obtaining the visual representation of the portion of the environment includes obtaining a visual representation of the one or more objects using the first data.

27. The method of claim 1, wherein the first object includes a plurality of layers, and
wherein modifying the first object within the visual representation to generate the second object includes:
removing at least one layer of the plurality of layers of the first object;
after removing the at least one layer of the plurality of layers of the first object, generating the second object that includes one or more layers of the first object but does not include the at least one layer of the plurality of layers that have been removed; and
obtaining an updated visual representation of the portion of the environment based at least on the second object.

28. The method of claim 1, wherein the action relating to the first object includes replacing the first object with the second object in the visual representation.

29. A non-transitory computer-readable medium having stored thereon instructions, which, when executed by a computer, cause the computer to perform operations comprising:
obtaining an estimated location of a computing device and an estimated orientation of the computing device;
sending a query indicating the estimated location and the estimated orientation of the computing device to a remote server;
receiving, from the remote server, first data representing at least a portion of an environment in which the computing device is located, wherein the first data includes an image of the portion of the environment, and wherein the image is stored at the remote server before receiving the first data;
obtaining a visual representation of the portion of the environment in which the computing device is located using the image of the portion of the environment received from the remote server;
providing, for display by the computing device, a user-interface including the visual representation of the portion of the environment in which the computing device is located;
receiving second data indicating (i) a selection of a first object within the visual representation that is obtained using the image received from the remote server, and (ii) an action relating to the object, wherein the action includes modifying the first object within the visual representation to generate a second object;
obtaining an updated visual representation of the portion of the environment in which the computing device is located based on the second data indicating (i) the selection of the first object within the visual representation, and (ii) the action relating to the first object, wherein the updated visual representation includes the second object and does not include the first object; and
providing, for display by the computing device, an updated user interface including the updated visual representation of the portion of the environment in which the computing device is located.

30. The computer-readable medium of claim 29, wherein the query includes a first image of the portion of the environment.

31. The computer-readable medium of claim 29, comprising:
obtaining a query image including a first representation of the portion of the environment in which the computing device is located,
wherein sending the query includes sending the query image including the first representation,
wherein receiving the first data includes receiving the image representing a second representation of the portion of the environment that is different from the first representation included in the query image.

32. The computer-readable medium of claim 31, wherein a visual perspective of the second representation is different from a visual perspective of the first representation.

33. The computer-readable medium of claim 29,
wherein the first data include information identifying one or more objects within the portion of the environment, and
wherein obtaining the visual representation of the portion of the environment includes obtaining a visual representation of the one or more objects using the first data.

34. The computer-readable medium of claim 29, wherein the first object includes a plurality of layers, and
wherein modifying the first object within the visual representation to generate the second object includes:
removing at least one layer of the plurality of layers of the first object;
after removing the at least one layer of the plurality of layers of the first object, generating the second object that includes one or more layers of the first object but does not include the at least one layer of the plurality of layers that have been removed; and
obtaining an updated visual representation of the portion of the environment based at least on the second object.

35. A system comprising:
one or more computers; and
a computer-readable medium having stored thereon instructions that, when executed by the one or more computers, cause the one or more computers to perform operations comprising:
obtaining an estimated location of a computing device and an estimated orientation of the computing device;
sending a query indicating the estimated location and the estimated orientation of the computing device to a remote server;
receiving, from the remote server, first data representing at least a portion of an environment in which the computing device is located, wherein the first data includes an image of the portion of the environment, and wherein the image is stored at the remote server before receiving the first data;
obtaining a visual representation of the portion of the environment in which the computing device is located using the image of the portion of the environment received from the remote server;
providing, for display by the computing device, a user-interface including the visual representation of the portion of the environment in which the computing device is located;
receiving second data indicating (i) a selection of a first object within the visual representation that is obtained using the image received from the remote server, and (ii) an action relating to the object, wherein the action includes modifying the first object within the visual representation to generate a second object;
obtaining an updated visual representation of the portion of the environment in which the computing device is located based on the second data indicating (i) the selection of the first object within the visual representation, and (ii) the action relating to the first object, wherein the updated visual representation includes the second object and does not include the first object; and
providing, for display by the computing device, an updated user interface including the updated visual representation of the portion of the environment in which the computing device is located.

36. The system of claim 35, wherein the query includes a first image of the portion of the environment.

37. The system of claim 35, comprising:
obtaining a query image including a first representation of the portion of the environment in which the computing device is located,
wherein sending the query includes sending the query image including the first representation,
wherein receiving the first data includes receiving the image representing a second representation of the portion of the environment that is different from the first representation included in the query image.

38. The system of claim 35,
wherein the first data include information identifying one or more objects within the portion of the environment, and
wherein obtaining the visual representation of the portion of the environment includes obtaining a visual representation of the one or more objects using the first data.

39. The system of claim 35, wherein the first object includes a plurality of layers, and
wherein modifying the first object within the visual representation to generate the second object includes:
removing at least one layer of the plurality of layers of the first object;
after removing the at least one layer of the plurality of layers of the first object, generating the second object that includes one or more layers of the first object but does not include the at least one layer of the plurality of layers that have been removed; and
obtaining an updated visual representation of the portion of the environment based at least on the second object.
